(19) United States
(12) Patent Application Publication
(10) Pub. No.: US 2022/0180303 A1
(43) Pub. Date: Jun. 9, 2022

(54) Mobile Inventory Systems and Methods

(71) Applicant: T&W Operations, Inc., Huntsville, AL (US)

(72) Inventors: Rick Head, Fayettville, TN (US); Aaron Valerio, Harvest, AL (US); Chris Honeycutt, Huntsville, AL (US)

(73) Assignee: T&W Operations, Inc., Huntsville, AL (US)

(21) Appl. No.: 17/544,479

(22) Filed: Dec. 7, 2021

Related U.S. Application Data
(60) Provisional application No. 63/122,463, filed on Dec. 7, 2020.

(51) Int. Cl. G06Q 10/08; G06K 19/077; G06K 7/10; H04B 17/318

(52) U.S. Cl. CPC G06Q 10/087; G06K 19/07758; H04B 17/318; G06K 7/10386; G06K 7/10297

(57) ABSTRACT

A system having a handheld device configured for activating a radio frequency identification (RFID) tag, a server communicatively coupled to the handheld device, and a processor that loads a database based on input from a user, the processor scans one or more RFID EPCs or corresponding label barcodes with the handheld device, determines whether each RFIG EPC and corresponding label barcode are in the database, and displays a list of inventory assets that were found in the database, not found in the database, or found in the inventory as extra.

### CROSS-REFERENCE TO RELATED APPLICATION

This application claims priority to U.S. Provisional Patent Application No. 63/122,463 entitled Systems and Methods Using RFID and filed on Dec. 7, 2020, which is incorporated by reference.

### BACKGROUND

Radio Frequency Identification (RFID) is a form of wireless communication that uses radio waves to identify and find objects. RFID is a generic term that encompasses different frequencies and standards, including both near-field communication (NFC) and radio frequency identification (RAIN) In simple terms, all RFID systems operate on the same principle: An RFID tag stores information that can be read wirelessly by an RFID reader.

There are two types of RFID tags. An active RFID tag comprises a microchip, antenna, and a battery. These components enable the device to transmit data even when there isn't a reader within range.

A passive RFID tags doesn't have an internal power source. The passive RFID tags use the electromagnetic waves received from a RFID reader/antenna to provide the energy necessary for the RFID Chip set to function and transmit the EPC from the RFID tag back to the RFID reader/antenna. Once a RFD reader antenna transmits to the RFID tag, an antenna inside the device creates a magnetic field energizing the RFID tag chip set. The tag circuit uses the power generated to transmit data hack to the RFID reader/antenna.

There is a myriad of uses of RFID technology. For example, RFID is used in supply chain management, asset tracking, or authentication of frequently counterfeited pharmaceuticals. Applications of RFID are unlimited.

### DESCRIPTION OF DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is an exemplary storage area that contains a plurality of storage boxes items on a plurality of shelves and each box comprises a radio frequency identification (RFID) tag.

FIG. 2 is a box diagram on exemplary reader such as is shown with reference to FIG. 1.

FIG. 3 is an exemplary reader such as is shown with reference to FIG. 1 displaying an exemplary Main graphical user interface (GUI).

FIG. 4 is the exemplary reader such as is shown with reference to FIG. 1 displaying an exemplary Load Database GUI.

FIG. 5 is the exemplary reader such as is shown with reference to FIG. 1 displaying an exemplary Scan GUI.

FIG. 6 is the exemplary reader such as is shown with reference to FIG. 1 displaying an exemplary Scan Results GUI.

FIG. 7 is the exemplary reader such as is shown with reference to FIG. 1 displaying an exemplary barcode identification GUI.

FIG. 8 is the exemplary reader such as is shown with reference to FIG. 1 displaying an exemplary Main menu.

FIG. 9 is exemplary reader such as is shown with reference to FIG. 1 displaying an exemplary Main GUI.

FIG. 10 is an exemplary reader such as is shown with reference to FIG. 1 displaying an exemplary Choose File GUI.

FIG. 11 is exemplary reader such as is shown with reference to FIG. 1 displaying an exemplary barcode identification GUI.

FIG. 12 is an exemplary reader such as is shown with reference to FIG. 1 displaying an exemplary Transfer GUI.

FIG. 13 is an exemplary reader such as is shown with reference to FIG. 1 displaying an exemplary scan results GUI.

FIG. 14 is an exemplary reader such as is shown with reference to FIG. 1 displaying an exemplary test GUI.

### DETAILED DESCRIPTION

The present disclosure is a mobile inventory system for use in taking inventory of a collection of items using radio frequency identification (RFID). In such a scenario, each item-has an RFID tag applied to one of its panels. The system comprises a handheld reader. In one embodiment, the tags are passive with no internal power source. In this case, the RFID tags are powered by the electromagnetic energy transmitted from the handheld reader. In another embodiment, the tag may be active. Active RFID systems use battery-powered RFID tags that continuously broadcast their own signal.

The exemplary mobile inventory system in accordance with an embodiment of the present disclosure comprises a handheld reader and a database server. In operation, a user may create a new database or a new two-dimensional database. For a new database, the user selects a file as a baseline database. In a new two-dimensional database, using the handheld device, the user can scan a plurality of items via quick response (QR) codes.

In operation, the user scans barcodes or QR codes to populate the database on the handheld device. With a list of barcodes, the user can create a database. The user can filter the data of the packages in the database or the user can Geiger the data of the packages in the database.

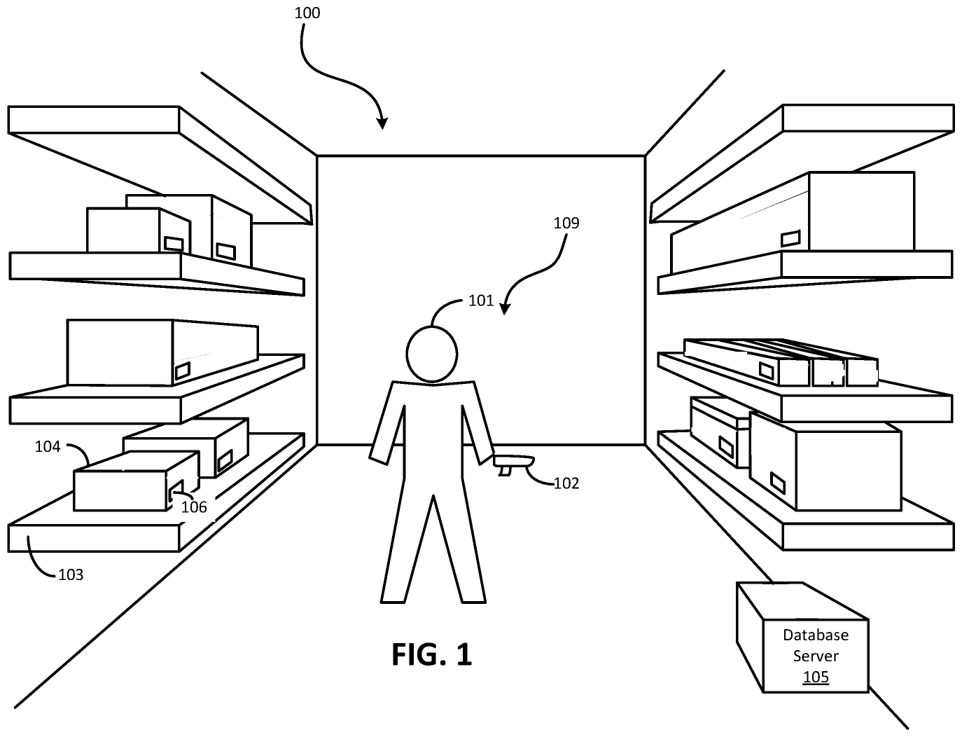

FIG. 1 is a room 100 suited to store inventory. In this regard, the inventory room 100 comprises shelving 103, i.e., four (4) shelves on each side of the room 100 that form an aisle 107. Boxes, packages, and other items 104 are stored on the four (4) shelves. The boxes, packages, and other items each have a unique RFID tag on an outside panel of the boxes, packages, or other items.

An inventory system 109 of the present disclosure comprises a handheld device 102 and a database server 105. Further, the system 109 is contained within the room 100 in the exemplary embodiment. The database server 105 may be in another room in other embodiments.

In operation, a user 101 holds a handheld device 102 in his hand. He walks down the aisle 107. He points the reader 102 at the boxes, packages, or other items 104. The electromagnetic field generated by the handheld energizes the RFID tags 106, and the RFID tags 106 energized transfers information about the box, package, or other item to which it is adhered.

The user 101 scans the boxes, packages, or other items 104. As the user is scanning the RFID tags 106, the handheld device 102 stores data received from the RFID tags 106. This data is unique to each box, package, or other item. The data received from the RFID tags 106 comprises data indicative of, for example, the number of items in a box or package and serial numbers of the items.

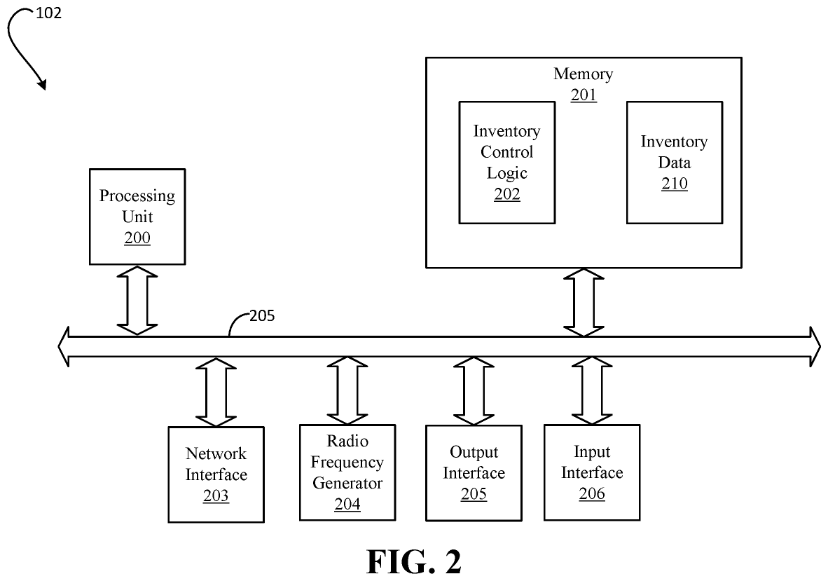

FIG. 2 is a block diagram of an exemplary handheld device 102 in accordance with an embodiment of the present disclosure. As shown by FIG. 2, handheld device 102 comprises at least a processing unit 200, a network interface 203, an input interface 206, an output interface 205, an RFID device, and memory 201. Stored in memory 201 is inventory control logic 202. The inventory control logic 202 may be software, hardware, firmware, or a combination thereof.

Further, the handheld device 102 comprises inventory data 210 stored in memory 210. The inventory data 210 can be data indicative of an inventory. For example, the inventory data comprises all the data necessary to identify a box, package or item

The exemplary embodiment of the handheld device 102 depicted by FIG. 2 comprises the at least one conventional processing unit 200, such as a Digital Signal Processor (DSP) or a Central Processing Unit (CPU), that communicates to and drives the other elements within the handheld device 102 via a local interface 205, which can include at least one bus. Further, the processing unit 200 is configured to execute instructions of software, such as the inventory control logic 202.

The inventory control logic 202 controls the functionality of the handheld device 102, and the present disclosure will describe in more detail hereafter. As noted above, the inventory control logic 202 can be implemented in software, hardware, firmware, or any combination thereof. In an exemplary embodiment illustrated in FIG. 2, the inventory control logic 202 is implemented in software and stored in memory 201.

Note that the control logic 202, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 206 may be, for example, a touch screen, a universal serial bus (USB), a keyboard, or a microphone. A user 101 (FIG. 1) may use one or more of the input interfaces 206 to input data into the handheld device 102. In this regard, the user may use the touch screen, the keyboard, the USB, or microphone to enter data for setting up the handheld device 102 or for modifying handheld device 102. Also, the input device 206 may be a camera (not shown) that receives images.

The output interface 205, for example, a display device (e.g., a Liquid Crystal Display (LCD)), outputs data to the user of the handheld device 102. In this regard, the inventory control logic 202 may display to the user GUIs configured to receive information for operating the handheld device 102.

In addition, the network interface 203, such as a Network Interface Card (NIC), enables the handheld device 102 to communicate via a network with the database server 105 (FIG. 1).

In operation, the inventory control logic 202 controls the operation of handheld device 102. In this regard, the handheld device 102 comprises an electromagnetic wave generator and an antenna. The electromagnetic waves activate a passive RFID tag 106 (FIG. 1) and the antenna receives data from the RFID tag about the box, package, or other item donning the RFID tag 106.

In one embodiment, a list of inventory is resident on the handheld device 102. Through use of the handheld device 102, the user can pinpoint multiple RFID tags 106 at the same time using tones and visual ques.

In this regard, while the handheld is in the Geiger mode and is scanning, tags will start to be received by the handheld device 102. The inventory control logic 202 compares each RFID tag 106 to a selected list on the handheld 102. That is, the tags are checked against the database with respect to the selected list.

If the user has selected the Found List via the handheld GUI (not shown) it will only Geiger found items. If the user selects the Not Found List, the handheld will only Geiger items not found. If the user has selected the Extra List, it will only Geiger extra items. Items in the Found List are items that are in the inventory database on the handheld device 102 and have been located. Items in the Not Found List are items in that are in the device inventory database but have not been located. Items in the Extras List are RFID tags that are not in the device inventory database but have been located in the vicinity of the room 100.

The Geiger portion of the functionality is driven by received signal strength indicator (RSSI) values contained in the data transmitted by the RFID tag. The RSSI value determines the strength of the returned signal from the RFID tag 106 after it has been energized by the RFID handheld 102. The RSSI values may be used in two ways.

First, the RSSI values may be used to determine which tone is used signaling the user that a tag has been seen. The tone to be used when a given RSSI value is received is defined using the tones step feature. The tones step feature enables a user to determine the type of tone that will be used given a range of RSSI strength, which can also be defined by the user. Secondly, the RSSI values are used to determine which color to make the row in the elected list. The color is defined within a two-color gradient. Color is calculated via the percentage value that represents the placement of the given tag RSSI value between Minimum and Maximum RSSI value. The Minimum and Maximum RSSI are defined using the tone steps feature.

In one example, the color gradient for the list items ranges from red for the lowest RSSI to green for the highest RSSI.

The handheld device's reader (not shown) is not tied to any specific manufacturer of RFID hardware. The handheld device' reader requires an implementation of the manufacturer's reader application program interface (API), but all interactions through the brands reader are handled through the handheld device's reader. All operations done upon the handheld device's reader, are done through the interface thus the handheld device's reader is uniquely capable of using any brand of reader.

Further, the handheld device's scanner interface is used to interface with any brand of barcode scanner, regardless of the brands implementation. The interface requires an implementation of the brand's scanner API, but all interactions through the brands scanner are handled through handheld device's agnostic scanner interface, so all operations done upon the handheld's scanner, are done through the interface thus the handheld device 102 is uniquely capable of using any brand of scanner.

The handheld device 102 uniquely supports the TIS application stored on server 105 (FIG. 1) by supplying the TIS application with configuration files that allow TIS to understand how the handheld device 102 is setup and how it will act in specific situations. For example, the handheld device may specify which directory on the device it places export data. This allows TIS to automatically pull export data from the specified directory when the device is connected via USB to the server 105. The handheld device 102 can specify which directory on the server 105 it wants TIS to place imported data. This allows TIS to automatically put imported data into a specific directory when the device 102 is connected via USB (shown).

The handheld device 102 can scan two-dimensional (2D) Barcodes that contain n number of items to create a catalog of assets. The catalog can be imported and inventoried leveraging the RFID technology.

When traditional methods of obtaining asset manifests are unavailable, it is difficult to validate the contents of a shipment. The handheld device 102 can compile a list of assets belonging to the shipment using a barcode format. Once the list is compiled, a user can then validate the shipment using RFID or traditional barcodes. Notably, each 2D Barcode contains data that is then parsed to create a list of inventoriable assets.

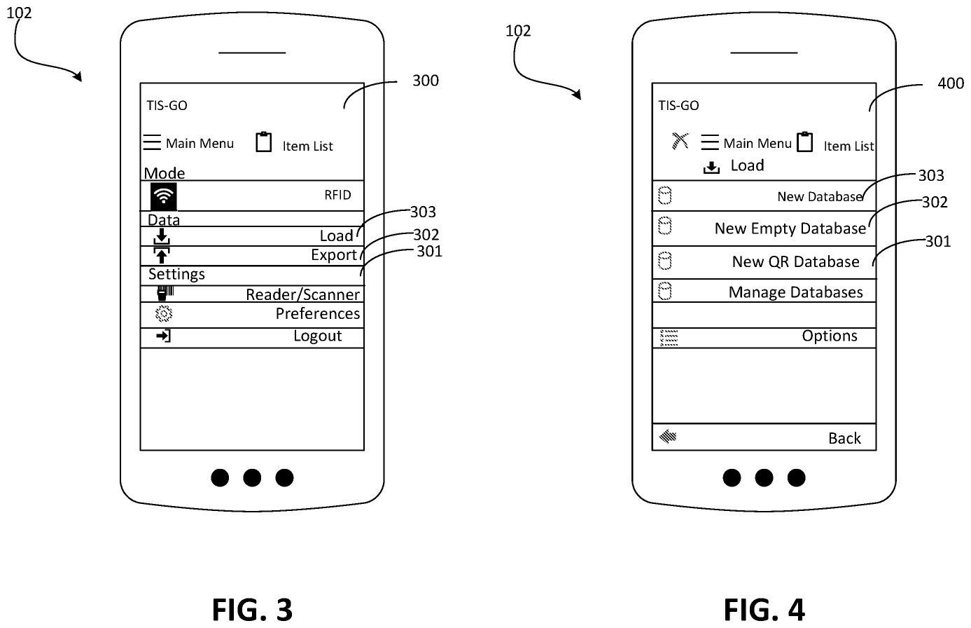

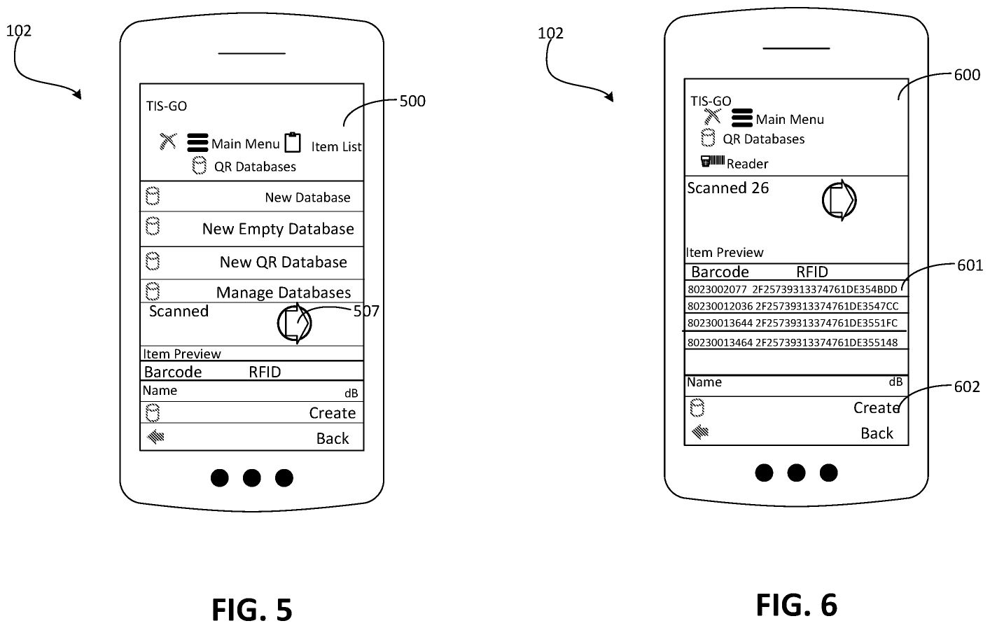

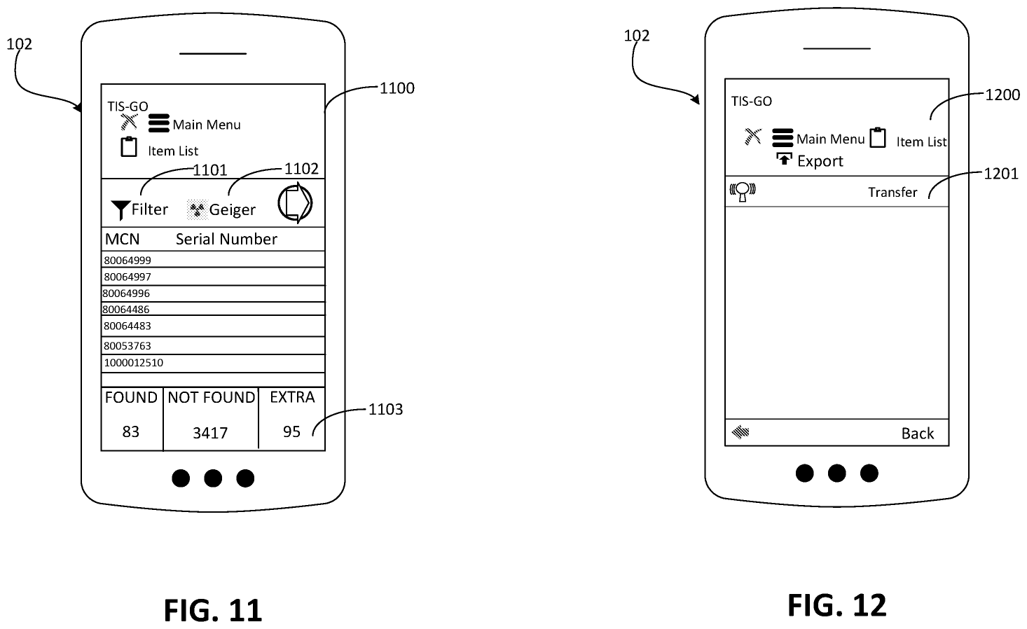

FIGS. 3-14 represent exemplary graphical user interfaces (GUIs) in accordance with an embodiment of the present disclosure. FIG. 3 is a main GUI 300 displayed by the handheld device 102 showing application flow for two-dimensional barcode asset validation.

From the main GUI 300 the user 101 may choose to augment the settings 301. Further, the user 101 can select the load link 303 or export link 302.

If the user selects load 303, the inventory control logic 202 displays the database GUI 400 in FIG. 4. From this GUI 400 a database is created. The user 101 can select the new database 401, the new empty database 402, or the new QR database 403.

From the scan GUI 500, the user 101 (FIG. 1) can select the arrow 507 and select Create. In response, the inventory control logic 202 displays information found in the scan. For example, the GUI 600 comprises a plurality of barcode and RFID numbers found in the scan. Note that GUI 600 states that “26” items were found.

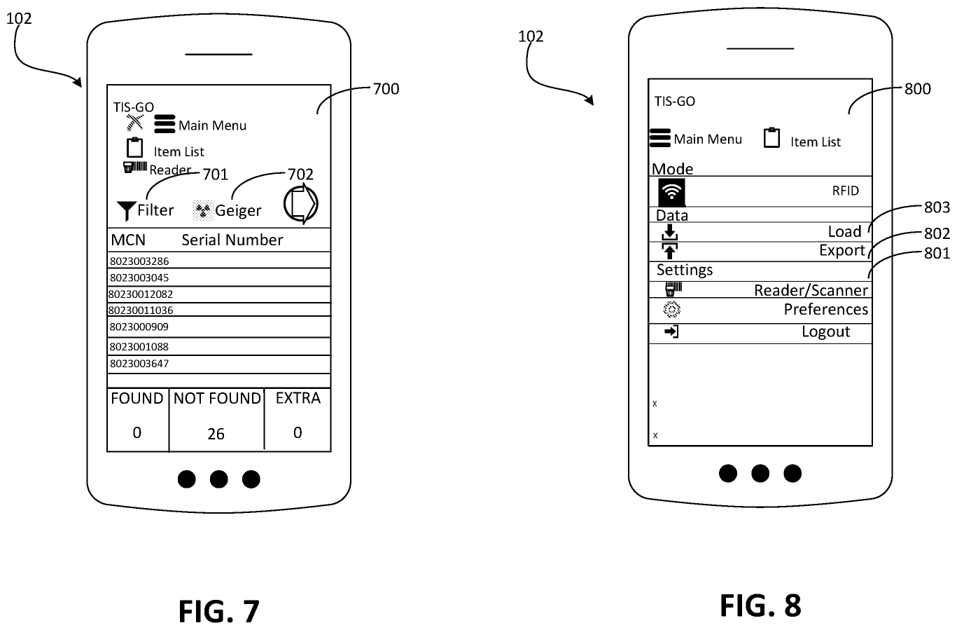

From GUI 600, the user 101 can select to “Create” an inventory of the barcodes and RFIDs displayed. In this regard, the user 101 selects a Create pushbutton 602. In response, the inventory control logic 202 displays the found GUI 700 in FIG. 7

The GUI 700 comprises a filter functionality and a Geiger functionality. In this regard, if a filter pushbutton 701 is selected, the user 101 can filter the listed results in a manner that the user 101 desires. If the Geiger pushbutton 702 is selected, the inventory control logic 202 displays the listed results using color coding. For example, if red is a low signal strength and green is a high signal strength, the inventory control logic 202 will display signals having a low signal strength red and signals having a high signal strength green. Further, between a minimum signal strength and a high signal strength, the inventory control logic 202 may display differing colors for those signals between the maximum and minimum. For example, if the signal strength is midway between the low signal strength and the high signal strength, the inventory control logic 202 may display the signal as orange.

Further, GUI 700 displays data indicative of signals found, e.g., 0, data indicative of signals not found, e.g., 26, and data indicative of signals that are extra, e.g., not found in the inventory but found when scanning boxes, packages, and other items.

FIG. 8 is a main GUI 800 displayed by the handheld device 102 showing application flow for inventor. From the main GUI 800 the user 101 may choose to augment the settings 801. Further, the user 101 can select the load link 803 or export link 802.

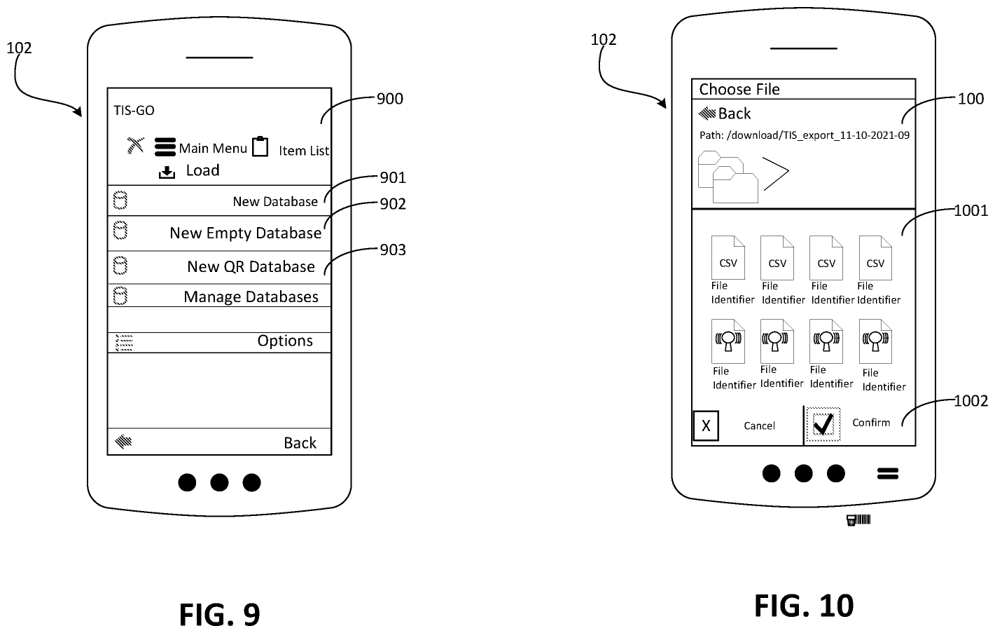

If the user selects load 803, the inventory control logic 202 displays the database GUI 900 in FIG. 9. From this GUI 900 a database is created. The user 101 can select the new database 901, the new empty database 902, or the new QR database 803.

From the choose file GUI 1000, the user 101 (FIG. 1) can select one of the files 1001 listed and select Confirm 1102. In response, the inventory control logic 202 displays information found in list GUI 1100.

The list GUI 1100 comprises a filter functionality and a Geiger functionality. In this regard, if a filter pushbutton 1101 is selected, the user 101 can filter the listed results in a manner that the user 101 desires. If the Geiger pushbutton 1102 is selected, the inventory control logic 202 displays the listed results using color coding. For example, if red is a low signal strength and green is a high signal strength, the inventory control logic 202 will display signals having a low signal strength red and signals having a high signal strength green. Further, between a minimum signal strength and a high signal strength, the inventory control logic 202 may display differing colors for those signals between the maximum and minimum. For example, if the signal strength is midway between the low signal strength and the high signal strength, the inventory control logic 202 may display the signal as orange.

Further, GUI 700 displays data indicative of signals found, e.g., 0, data indicative of signals not found, e.g., 26, and data indicative of signals that are extra, e.g., not found in the inventory but found when scanning boxes, packages, and other items.

Further, the GUI 1100 displays information regarding the scan. For example, the GUI 1100 displays eighty-three (83) for found items. The GUI 1100 displays three thousand four hundred and seventeen (3417) for items not found, and GUI 1100 displays ninety-five (95) for extra items found in the inventory.

FIG. 12 is the handheld device 102 displaying an export GUI 1200 in accordance with an embodiment of the present disclosure. In this regard, if the user 101 desires to export an inventory to the server 105, the user selects the transfer pushbutton 1201.

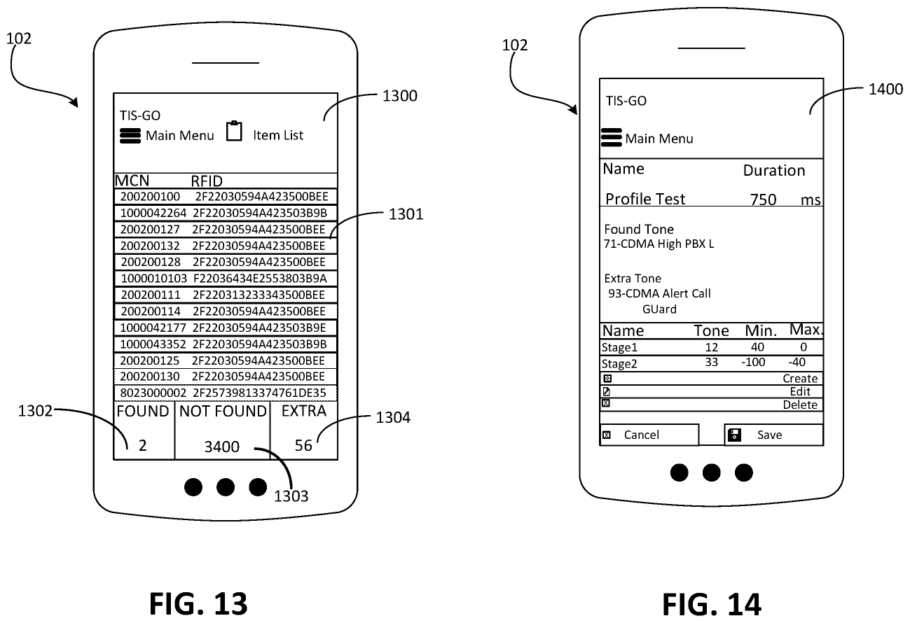

FIG. 13 is an inventory list GUI 1300 showing a list of boxes, packages, or other items not found in an inventory, if the not found pushbutton 1303 is selected. If the user selects the extra pushbutton 1304, boxes, packages or other items found during the scan but not located in the database are displayed. If the user 101 selects the found pushbutton 1302 is selected, the inventory control logic 202 displays data indicative of boxes, packages, or items found in the inventory and located in the database.

FIG. 14 is a settings GUI 1400 that enables the user 101 to make changes to the way boxes, packages, or items are displayed and communicated to the user 101. As indicated herein, each entry may display a color indicative of the signal strength. In addition, tones may sound indicative of signal found or extra entries in the inventory.

Notably, the user 101 can select a tone for a particular action. For example, for Stage 1, the tone is 12. However, for Stage 2, the tone is 33. The user 101 may edit these numbers to edit the tone.

The user 101 may also edit the minimum and maximum signal strength. Notably, for Stage 1, the minimum signal strength is 40 and the maximum signal strength is 0. For Stage 2, the minimum signal strength is −100 and the maximum signal strength is −400. The user can edit the minimum and maximum values to change the look and feel of a list of entries from a scan.

What I claim is:

1. A system, comprising:
a handheld device configured for activating a radio frequency identification (RFID) tag;
a server communicatively coupled to the handheld device;
a processor configured for loading a database based on input from a user, the processor further configured for scanning one or more barcodes with the handheld device, for determining whether each barcode is in the database, and for displaying a list of inventory assets that were found in the database, not found in the database, or found in the inventory as extra.

2. The system of claim 1, wherein the processor is configured for displaying a main menu to the user for selecting whether to load or export an inventory.

3. The system of claim 1, wherein the main menu further comprises a settings selection, and the processor is further configured for receiving data indicative of the reader/scanner, preferences, and logout.

4. The system of claim 1, wherein the processor is further configured for displaying types of databases for selection

5. The system of claim 4, wherein the processor is further configured to receive a selection of the type of database.

6. The system of claim 5, wherein the types of databases comprise a new database, a new empty database, or a new QR database.

7. The system of claim 6, wherein the processor scans boxes, packages, and/or other items.

8. The system of claim 7, wherein the processor is configured for displaying results of a scan.

9. The system of claim 8, wherein the processor is configured for creating a database of inventory assets based upon the results of the scan.

10. The system of claim 1, wherein the processor is further configured to search an inventory of multiple RFID tags at the same time using tones and visual ques.

11. The system of claim 1, wherein the processor is further configured to display items in a list wherein the color of the item in the list indicates signal strength.

12. The system of claim 11, wherein the handheld device receives data indicative of received signal strength indicators for each RFID tag read.

13. The system of claim 12, wherein the processor determines a time to signal the user that a RFID tag has been found.

14. The system of claim 12, wherein the processor determines which color to make the row in the elected list.

15. The system of claim 14, wherein the color is defined within a two-color gradient.

16. The system of claim 15, wherein the processor further calculates, via a percentage value that represents placement of the tag received signal strength indicator (RSSI) value between minimum and maximum RSSI values.

17. The system of claim 1, wherein the processor is further configured to receive data indicative of changes in tones and visual ques.

18. The system of claim 1, wherein the processor is further configured for receiving data indicative of a minimum and maximum signal strength for an item.

19. The system of claim 1, wherein the processor is configured for displaying a number indicative of scanned items found in the database, a number indicative of items in the database not found in when scanned, and a number indicative of items in the database that are not found in inventory.
